(19) United States
(12) Patent Application Publication
(10) Pub. No.: US 2026/0273947 A1
(43) Pub. Date: Sep. 17, 2026

(54) LIQUID CONTAINER AND LIQUID EJECTING APPARATUS

(71) Applicant: BROTHER KOGYO KABUSHIKI KAISHA, Nagoya (JP)

(72) Inventor: Yoshimori OSAKABE, Seto (JP)

(73) Assignee: BROTHER KOGYO KABUSHIKI KAISHA, Nagoya (JP)

(21) Appl. No.: 19/562,145

(22) Filed: Mar. 10, 2026

(30) Foreign Application Priority Data
Mar. 14, 2025 (JP) 2025-041870

(51) Int. Cl. B41J 2/175; B41J 29/13

(52) U.S. Cl. CPC B41J 2/17556; B41J 2/17523; B41J 2/17553; B41J 29/13

(57) ABSTRACT

An image recording apparatus includes: a head unit including a head; a supply tube having an end connected to the head, and configured to supply a recording material to the head; and a moving mechanism configured to move the head unit. The head unit has a joint member connected to the supply tube. The moving mechanism has a plurality of pulleys, a belt wound around the plurality of pulleys, and a belt-retained part configured to be retained with respect to the belt. The head unit is detachable from and attachable to the belt-retained part, and is connected to the belt via the belt-retained part in a state where the head unit is attached to the belt-retained part.

### REFERENCE TO RELATED APPLICATIONS

This application claims priority from Japanese Patent Application No. 2025-041870 filed on Mar. 14, 2025. The entire content of the priority application is incorporated herein by reference.

### BACKGROUND ART

As an example of a liquid container which stores liquid, an ink tank is known. A certain known ink tank includes an ink accommodating part which accommodates an ink, an atmospheric air communication port which communicates with the ink accommodating part, and a gas-liquid separation film which is permeable to gas and impermeable to liquid. The gas-liquid separation film is attached to an upper portion of the ink tank so that the gas-liquid separation film covers the atmospheric air communication port.

### SUMMARY

In the above-described ink tank, the gas-liquid separation film sometimes malfunctions due to, for example, any damage to the gas-liquid separation film, or a foreign matter or the ink clogging the gas-liquid separation film. In such a situation, the entire ink tank, to which the gas-liquid separation film is attached, is required to be replaced with a new ink tank. However, a user cannot replace the ink tank by himself or herself in some cases. In such a case, the user is required to request a repair technician, from a repair service provider such as the manufacturer of the ink tank, to replace the ink tank. On the other hand, since the repair technician replaces the entire ink tank, the repair technician is required to detach and attach a cover which covers the surroundings of the ink tank, resulting in a significant disassembling operation with respect to the recording apparatus. Further, the repair technician is also required to detach and attach a tube, connecting to a head which ejects the ink, with respect to the ink tank. In this procedure, such a problem easily arises that the new ink tank is contaminated with the ink, and that the ink cannot be ejected from the head due to any connection failure in the tube.

An object of the present disclosure is to provide a liquid container and a liquid ejecting apparatus in each of which a gas-liquid separation film can be easily replaced.

The present disclosure relates to a liquid container. The liquid container includes: a storage part which includes a storage chamber configured to store liquid, and a communication part communicating with the storage chamber; and a connection component configured to be detachably connected to the communication part. The connection component includes: a connection part connected to the communication part; an atmosphere-open part configured to communicate with outside; a first communication channel via which the atmosphere-open part communicates with the connection part; and a gas-liquid separation film which is disposed in the first communication channel, and which is impermeable to the liquid and permeable to air.

In a case where the liquid contained in the storage chamber is consumed, the air flows into the storage chamber from the atmosphere-open part via the first communication channel, the connection part, and the communication part. On the other hand, for example, even in a case where the liquid contained in the storage chamber flows into the first communication channel due to the vibration caused during the transport of the liquid container, the liquid cannot pass through the gas-liquid separation film. Accordingly, the liquid contained in the storage chamber is reduced from leaking to the outside of the liquid container via the atmosphere-open part. Further, the gas-liquid separation film malfunctions in some cases due to, for example, any damage to the gas-liquid separation film, or any foreign matter or the liquid clogging the gas-liquid separation film. In the above-described configuration, the connection component, which includes the gas-liquid separation film, is attachable to and detachable from the communication part. Accordingly, in a case where the connection component is replaced with a new connection component, the gas-liquid separation film can also be replaced. In other words, the entire liquid container is not required to be replaced with a new liquid container in order to replace the gas-liquid separation film. This allows a user to easily replace the gas-liquid separation film.

According to the present disclosure, the gas-liquid separation film can be easily replaced.

### BRIEF DESCRIPTION OF DRAWINGS

FIG. 1 is a perspective view of the appearance of a multi-functional peripheral 10.

FIG. 2 is a vertical cross-sectional view schematically illustrating the internal structure of a printer part 11.

FIG. 3 is a plan view illustrating the disposition of a carriage 23 and an ink tank 90.

FIG. 4 is a perspective view of the ink tank 90.

FIG. 5 is a partial cross-sectional view illustrating the surroundings of the ink tank 90 including a connection component 120.

FIG. 6 is an exploded perspective view of the connection component 120.

FIG. 7 is a vertical cross-sectional view of an ink bottle 80.

FIG. 8 is a partial cross-sectional view illustrating a state where the ink bottle 80 is connected to a tank body 100.

FIG. 9 is a schematic view of an ink tank 90.

FIG. 10 is a schematic view of an ink tank 90.

FIG. 11 is a schematic view of a cartridge 410 to which a connection component 120 is mounted.

FIG. 12 is a cross-sectional view illustrating a cartridge 410 and a sub-tank 160 to which the cartridge 410 is detachably connected.

FIG. 13 is a partial cross-sectional view illustrating a state where a connection component 120 is mounted to an annular contact wall 122.

FIG. 14 is a perspective view of an ink tank 90.

FIG. 15 is a perspective view of a cover 70 as viewed from the rear.

FIG. 16 is a partial cross-sectional view illustrating a state where a retaining part 181 is in contact with an upper surface of a closing wall of a connection component 120.

FIG. 17 is a partial cross-sectional view illustrating a state where a connection component 120 is mounted to an ink tank 90.

### DESCRIPTION

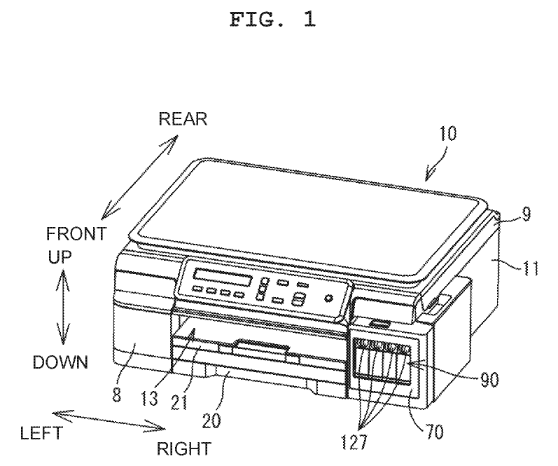

An embodiment of the present disclosure will be described below. Note that the embodiment described below is merely an example of the present disclosure. Needless to say that the embodiment of the present disclosure can be appropriately changed, without changing the gist of the present disclosure. In the following description, as illustrated in FIG. 1, the up-down direction is defined based on a state where a multi-functional peripheral 10 is usably placed. The front-rear direction is defined with the side, in which a discharge port 13 is defined, as the front. The left-right direction is defined, with the multi-functional peripheral 10 as viewed from the front. The front-rear direction, the up-down direction, and the left-right direction are orthogonal to one another.

### Overall Configuration of Multi-functional Peripheral 10

As illustrated in FIG. 1, the multi-functional peripheral 10 includes a casing 8 having a substantially rectangular parallelepiped shape. The multi-functional peripheral 10 includes a scanner part 9 and a printer part 11 in the internal space of the casing 8. The scanner part 9 is positioned at an upper portion of the internal space of the casing 8. The scanner part 9 has a scanning function.

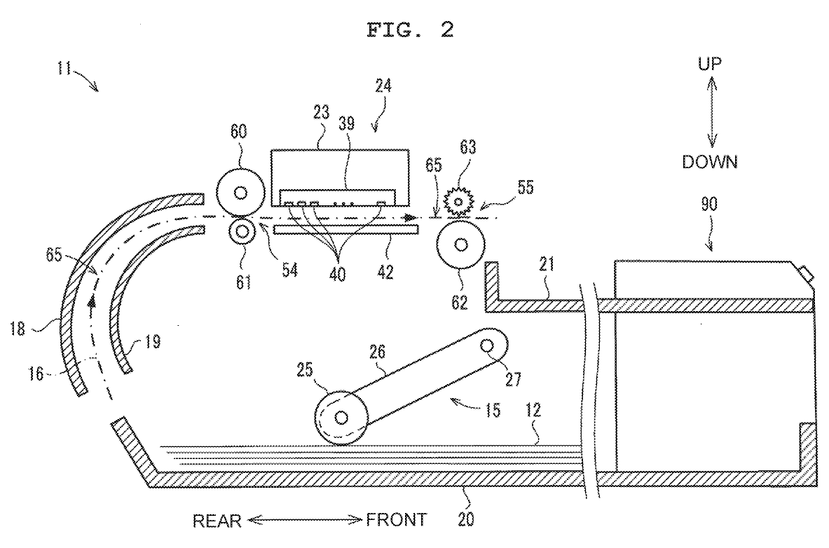

The printer part 11 is positioned below the scanner part 9 in the internal space of the casing 8. The printer part 11 has a printing function. The printer part 11 records an image on a sheet 12, as illustrated in FIG. 2, in the ink-jet recording system. The printer part 11 is an example of the liquid ejecting apparatus. The printer part 11 includes a feed part 15, a feed tray 20, a discharge tray 21, a conveyance path 65, a conveyance roller part 54, a recording part 24, a discharge roller part 55, and a platen 42. Further, as illustrated in FIG. 1, the printer part 11 includes an ink tank 90.

### Feed Tray 20, Discharge Tray 21

The discharge port 13 is positioned at a central portion in the left-right direction on the front surface of the casing 8. The feed tray 20 is movable in the front-rear direction through the discharge port 13 in accordance with an operation performed by a user. As illustrated in FIG. 2, the feed tray 20 supports a plurality of stacked sheets 12. The discharge tray 21 is positioned above the feed tray 20. The discharge tray 21 is movable in the front-rear direction together with the feed tray 20. The discharge tray 21 supports the sheets 12 discharged by the discharge roller part 55.

### Feed Part 15

The feed part 15 feeds the sheet 12 supported by the feed tray 20 to the conveyance path 65. The feed part 15 includes a feed roller 25, a feed arm 26, and a shaft 27. The feed roller 25 is rotatably supported at a forward end portion of the feed arm 26. The driving force is transmitted from a non-illustrated conveyance motor to the feed roller 25 to thereby rotate the feed roller 25 in such a direction that the sheet 12 is conveyed in the conveyance direction 16. The rotation of the feed roller 25, the conveyance roller 60, and the discharge roller 62 in the direction to convey the sheet 12 in the conveyance direction 16 is hereinafter referred to as "forward rotation".

The feed arm 26 is rotatably supported by the shaft 27 which is supported by the frame of the printer part 11. The feed arm 26 extends rearward and downward from the shaft 27. The feed arm 26 is urged by the self-weight or any elastic force exerted, for example, by a spring so that the feed arm 26 pivots downward.

### Conveyance Path 65

The conveyance path 65 refers to a space which is defined, for example, by an outer guide member 18 and an inner guide member 19 which face each other at a predetermined spacing. The conveyance path 65 extends from a rear end portion of the feed tray 20 to the rear of the printer part 11. The conveyance path 65 makes a U-turn while extending upward from a position closely adjacent to a rear end of the feed tray 20, and the conveyance path 65 extends frontward in a space between the recording part 24 and the platen 42. The conveyance path 65 passes through the space between the recording part 24 and the platen 42, and the conveyance path 65 reaches the discharge tray 21.

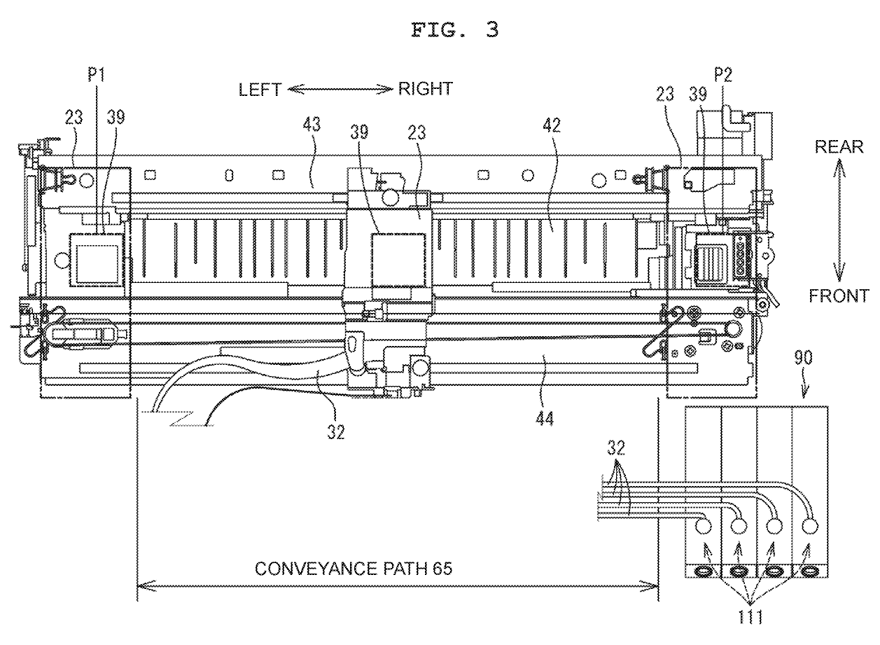

As illustrated in FIG. 3, a portion, in the conveyance path 65, between the conveyance roller part 54 and the discharge roller part 55, is positioned at a central portion in the left-right direction of the multi-functional peripheral 10. The conveyance direction 16 of the sheet 12 in the conveyance path 65 is illustrated by an arrow of an alternate long and short dash line in FIG. 2.

### Conveyance Roller Part 54

As illustrated in FIG. 2, the conveyance roller part 54 is positioned upstream of the recording part 24 in the conveyance direction 16. The conveyance roller part 54 includes a conveyance roller 60 and a pinch roller 61. The conveyance roller 60 and the pinch roller 61 face each other in the up-down direction. The conveyance roller 60 rotates as the drive from the conveyance motor is transmitted to the conveyance roller 60. The pinch roller 61 rotates following the rotation of the conveyance roller 60. The conveyance motor rotates forward to thereby cause the conveyance roller 60 to rotate forward and to convey the sheet 12 in the conveyance direction 16 while the conveyance roller 60 holds the sheet 12 between the conveyance roller and the pinch roller 61.

### Discharge Roller Part 55

The discharge roller part 55 is positioned downstream of the recording part 24 in the conveyance direction 16. The discharge roller part 55 includes a discharge roller 62 and a spur 63. The discharge roller 62 and the spur 63 face each other in the up-down direction. The discharge roller 62 rotates as the drive from the conveyance motor is transmitted to the discharge roller 62. The spur 63 rotates following the rotation of the discharge roller 62. The conveyance motor rotates forward to thereby cause the discharge roller 62 to rotate forward and to convey the sheet 12 in the conveyance direction while the discharge roller 62 holds the sheet 12 between the discharge roller 62 and the spur 63.

### Recording Part 24

The recording part 24 is positioned between the conveyance roller part 54 and the discharge roller part 55 in the conveyance direction 16. The recording part 24 faces the platen 42 in the up-down direction, with the conveyance path 65 being interposed between the recording part 24 and the platen 42. The recording part 24 is positioned above the conveyance path 65 in the up-down direction. The recording part 24 includes a carriage 23 and a recording head 39.

As illustrated in FIG. 3, the carriage 23 is supported by guide rails 43 and 44. The guide rails 43 and 44 are supported by the frame of the printer part 11. The guide rails 43 and 44 are spaced apart from each other in the front-rear direction, and the guide rails 43 and 44 extend in the left-right direction. The guide rails 43 and 44 extend up to a location which is to the left, and beyond, the conveyance path 62, and extend to a location which is to the right, and beyond, the conveyance path 65 in the left-right direction. The carriage 23 is connected to a known belt mechanism disposed in the guide rail 44.

The belt mechanism rotates or runs as the drive from a non-illustrated carriage motor is transmitted to the belt mechanism. The belt mechanism runs to thereby cause the carriage 23 to move in the left-right direction. The range of movement of the carriage 23 is depicted by alternate long and short dash lines in FIG. 3. The carriage 23 is movable up to a location to the left, and beyond, the conveyance path 62 and to a location to the right, and beyond, the conveyance path 65 in the left-right direction.

The recording head 39 is mounted to the carriage 23. The recording head 39 is movable in the left-right direction integrally with the carriage 23. The recording head 39 moves between a standby position P1 and a maintenance position P2. The standby position P1 is located to the left, and beyond, the conveyance path 65. The maintenance position P2 is located to the right, and beyond, the conveyance path 65.

As illustrated in FIG. 2, the recording head 39 includes a plurality of nozzles 40 which are positioned in the lower surface of the recording head 39. As illustrated in FIG. 3, the recording head 39 is connected to the ink tank 90, which will be described later, by an ink tube 32. The ink tube 32 supplies ink stored in the ink tank 90 to the recording head 39. The recording head 39 is capable of ejecting the ink from the plurality of nozzles 40. The recording head 39 ejects the ink as minute ink droplets toward the sheet 12 supported by the platen 42 during a process in which the carriage 23 is moved in the left-right direction. Accordingly, an image is recorded on the sheet 12.

### Platen 42

As illustrated in FIG. 2, the platen 42 is positioned between the conveyance roller part 54 and the discharge roller part 55 in the conveyance direction 16. The platen 42 faces the recording part 24 in the up-down direction. The platen 42 supports, from below, the sheet 12 conveyed by the conveyance roller part 54.

### Ink tank 90

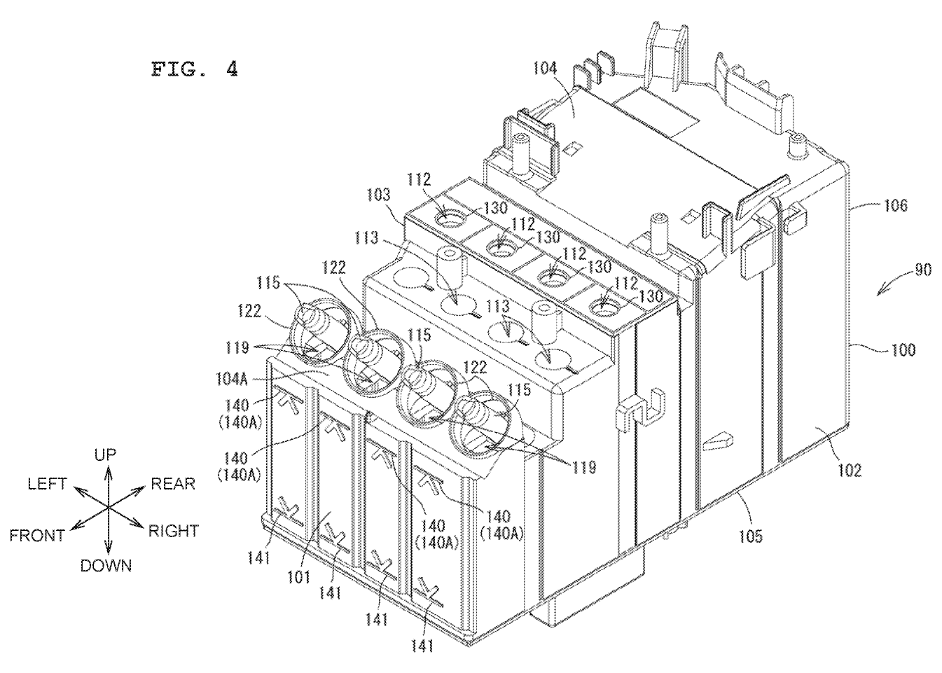

As illustrated in FIGS. 1 and 4, the ink tank 90 is disposed at a right end portion in the internal space of the casing 8. The ink tank 90 is fixed to the frame of the printer part 11 so that the user cannot remove the ink tank 90 easily from the internal space of the casing 8. The casing 8 is an example of the casing.

An opening, which is defined by the casing 8, is formed in a right end portion of the front surface of the casing 8. The ink tank 90 is positioned to the rear of the opening of the casing 8. A cover 70, which is capable of opening/closing the opening of the casing 8, is disposed. The cover 70 is rotatable about the rotation shaft extending in the left-right direction. The rotation shaft is positioned at a lower end portion of the casing 8. An opening having a rectangular shape is defined in the cover 70. Accordingly, the user is able to visually recognize a part of the ink tank 90 which is, for example, a tank cap 127, which will be described later, through the opening from the front.

The cover 70 is rotatable between a closed position and an open position. The closed position is a position at which the cover 70 closes the opening of the casing 8. The open position is a position at which the cover 70 is rotated frontward from the closed position. The cover 70 located at the open position opens the opening of the casing 8.

As illustrated in FIGS. 1, 3, 4 and 5, the ink tank 90 includes a tank body 100, four tank caps 127, and a connection component. Note that in FIG. 4, the connection component 120 is omitted. The ink tank 90 is an example of the tank and the liquid container. The tank body 100 is an example of the storage part. The tank body 100 includes a front wall 101, a right wall 102, a left wall 103, an upper wall 104, a lower wall 105, and a rear wall 106.

The tank body 100 includes four ink chambers 111. The four ink chambers 111 are disposed side by side in the left-right direction. Each of the four ink chambers 111 stores a corresponding one of inks of mutually different colors which are yellow, cyan, magenta, and black. Each of the four ink chambers 111 are comparted by the front wall 101, the right wall 102, the left wall 103, the upper wall 104, the lower wall 105, the rear wall 106, and three non-illustrated division walls. The three division walls are positioned inside the tank body 100 while being spaced apart from one another in the left-right direction. The ink chamber 111 is an example of the storage chamber. The ink is an example of the liquid.

The front wall 101 includes upper lines 140 and lower lines 141 which are positioned on the front surface of the front wall 101. The upper lines 140 are positioned at an upper portion of the front wall 101. Each of the upper lines 140 is a line extending in the left-right direction. Each of the upper lines 140 indicates a highest position 140A of the liquid surface of the ink which can be stored in the ink chamber 111. Note that the four upper lines 140 are disposed corresponding to the four ink chambers 111, respectively.

The lower lines 141 are positioned at a lower portion of the front wall 101. Each of the lower lines 141 is a line extending in the left-right direction. Each of the lower lines 141 indicates that the ink is required to be supplied to the ink chamber 111 in a case where the liquid surface of the ink is located at the position of the lower line 141. Note that the four lower lines 141 are disposed corresponding to the four ink chambers 111, respectively.

The upper wall 104 includes four communication parts 130 which project upward from the upper wall 104. The four communication parts 130 are positioned at a central portion in the front-rear direction of the upper wall 104. The four communication parts 130 are aligned at equal intervals in the left-right direction. Each of the four communication parts 130 has a ring shape, as viewed from above. The entirety of the inner circumferential surface of each of the four communication parts 130 defines an atmospheric air communication port 112. The four atmospheric air communication ports 112 of the four communication parts 130 extend through the upper wall 104 in the up-down direction. Each of the four atmospheric air communication ports 112 is circular as viewed from above.

The leftmost atmospheric air communication port 112, among the four atmospheric air communication ports 112, is open in the leftmost ink chamber 111 among the four ink chambers 111. The second atmospheric air communication port 112 from the left is open to the second ink chamber 111 second from the left. The third atmospheric air communication port 112 from the left is open to the third ink chamber 111 from the left. The rightmost atmospheric air communication port 112 is open to the rightmost ink chamber 111.

The upper surface of the upper wall 104 includes an inclined surface 104A. The inclined surface 104A is positioned at a front end portion of the upper surface of the upper wall 104. The inclined surface 104A is inclined with respect to the front-rear direction so as to extend downward as the inclined surface 104A extends frontward. The inclined surface 104A ranges from the left end to the right end of the ink tank 90.

Four openings 113 are defined in the upper wall 104. The four openings 113 are positioned to the front of the four atmospheric air communication ports 112, respectively. The four openings 113 extend through the upper wall 104 in the up-down direction. The four openings 113 are aligned at equal intervals in the left-right direction.

The leftmost opening 113, among the four openings 113, communicates with the leftmost ink chamber 111. The second opening 113 from the left communicates with the second ink chamber 111 from the left. The third opening 113 from the left communicates with the third ink chamber 111 from the left. The rightmost opening 113 communicates with the rightmost ink chamber 111.

A non-illustrated outflow tube is connected to each of the four openings 113. The outflow tube is a tube body having a circular shape and extending downward from each of the four openings 113. The lower end of the outflow tube is open downward. The upper end of the outflow tube communicates with the ink tube 32 illustrated in FIG. 3. Accordingly, the ink, which is stored in each of the four ink chambers 111, is supplied to the recording head 39 via the outflow tube and the ink tube 32. In response to the ink contained in the ink chamber 111 being consumed in accordance with the ejection of the ink from the recording head 39, the air flows into each of the four ink chambers 111 via a corresponding one of the four atmospheric air communication ports 112.

Four annular contact walls 122 are positioned on the inclined surface 104A of the upper wall 104. The four annular contact walls 122 are disposed at equal intervals in the left-right direction. The four annular contact walls 122 extend upward and frontward from the inclined surface 104A. In the following description, the upward and frontward direction is referred to as "extending direction". Each of the four annular contact walls 122 has an annular shape as viewed in the extending direction.

The internal space of the leftmost annular contact wall 122 communicates with the leftmost ink chamber 111 via a corresponding one of four inlet ports 119 which will be described later. The internal space of the second annular contact wall 122 from the left communicates with the second ink chamber 111 from the left via a corresponding one of the four inlet ports 119. An internal space of the third annular contact wall 122 from the left communicates with the third ink chamber 111 from the left via a corresponding one of the four inlet ports 119. An internal space of the rightmost annular contact wall 122 communicates with the rightmost ink chamber 111 via a corresponding one of the four inlet ports 119.

Four tank tube members 115 are positioned inside the four annular contact walls 122, respectively. Each of the four tank tube members 115 is a circular tube extending in the extending direction from the inclined surface 104A. Each of the four tank tube members 115 extends, in the extending direction, beyond an end in the extending direction of a corresponding one of the four annular contact walls 122. One end in the extending direction of each of the four tank tube members 115 is open. The other end, of each of the four tank tube members 115, opposite to the one end in the extending direction is open to the ink chambers 111.

The leftmost tank tube member 115 communicates with the leftmost ink chamber 111. The second tank tube member 115 from the left communicates with the second ink chamber 111 from the left. The third tank tube member 115 from the left communicates with the third ink chamber 111 from the left. The rightmost tank tube member 115 communicates with the rightmost ink chamber 111.

Each of the four inlet ports 119 is positioned inside a corresponding one of the four annular contact walls 122. Each of the four inlet ports 119 is open in the inclined surface 104A. The leftmost inlet port 119, among the four inlet ports 119, allows the leftmost ink chamber 111 to communicate with the outside. The second inlet port 119 from the left allows the second ink chamber 111 from the left to communicate with the outside. The third inlet port 119 from the left allows the third ink chamber 111 from the left to communicate with the outside. The rightmost inlet port 119 allows the rightmost ink chamber 111 to communicate with the outside.

As illustrated in FIG. 1, the four tank caps 127 are disposed. The four tank caps 127 are detachably connected to the four annular contact walls 122, respectively. Each of the four tank caps 127 is a cylindrical member having a closed one end. Each of the tank caps 127 is forcibly inserted into a corresponding one of the four annular contact walls 122 to thereby close a corresponding one of the tank tube members 115 and a corresponding one of the inlet ports 119. Accordingly, any foreign matter such as dust can be reduced from entering into the ink chamber 111 via the tank tube member 115 and the inlet port 119, and the ink can be reduced from leaking from the ink chamber 111. The tank cap 127 is an example of the cap.

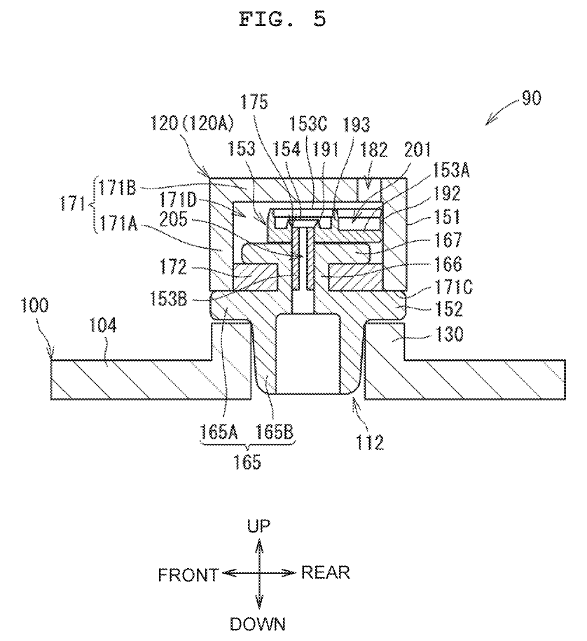

Each of the four connection components 120 is detachably connected to a corresponding one of the four communication parts 130. Note that the four connection components 120 have the same structure. Therefore, in the following description, only one connection component 120A, among the four connection components 120, which is illustrated in FIG. 5, will be described. The description of the connection component 120A also applies to the remaining three connection components 120.

The connection component 120A includes a housing 151, a seal member 152, a channel member 153, and a gas-liquid separation film 154. The housing 151 has a cylindrical shape extending in the up-down direction. Specifically, the housing 151 includes a cylindrical member 171 and a flange 172. The cylindrical member 171 has a cylindrical shape extending in the up-down direction. A lower end 171C of the cylindrical member 171 is open downward. The up-down direction is an example of the first direction. The lower end 171C of the cylindrical member 171 is an example of the one end in the first direction of the cylindrical member. The cylindrical member 171 includes a cylindrical part 171A and a closing wall 171B.

The cylindrical part 171A has a cylindrical shape extending in the up-down direction. The cylindrical part 171A has an inner diameter which is slightly larger than an inner diameter of the communication part 130. The closing wall 171B is positioned at the upper end of the cylindrical part 171A. The closing wall 171B closes the upper end of the cylindrical part 171A. The closing wall 171Bhas a flat plate shape expanding in the front-rear direction and the left-right direction. The closing wall 171B is circular as viewed from above. The lower surface of the closing wall 171B and the inner circumferential surface of the cylindrical member 171A define an accommodating space 171D having a columnar shape. The accommodating space 171D is an example of the accommodating chamber.

The closing wall 171B defines an atmospheric port 182 which is open to the atmosphere. The atmospheric port 182 extends through the closing wall 171B in the up-down direction. The atmospheric port 182 allows the accommodating space 171D of the cylindrical member 171 to communicate with the outside. The atmospheric port 182 is positioned to the rear of the center of the closing wall 171B. The closing wall 171B is an example of the atmosphere-open part. The flange 172 is positioned at the lower end of the inner circumferential surface of the cylindrical member 171A. The flange 172 has a ring shape extending inward in the radial direction of the cylindrical member 171A from the inner circumferential surface of the cylindrical member 171A.

The seal member 152 is attached to the lower end 171C of the cylindrical member 171. The seal member 152 has a cylindrical shape extending in the up-down direction. The seal member 152 is an elastic member made of silicon or rubber. The seal member 152 includes a seal body 165, an extending part 166, and a contact part 167.

The seal body 165 is positioned at the lower end 171C of the cylindrical member 171. The seal body 165 includes an annular wall 165A and a cylindrical wall 165B. The annular wall 165A has a flat plate-shape expanding in the up-down direction and the left-right direction. The annular wall 165A has a ring shape. The upper surface of the annular wall 165A contacts the entire circumference of the lower end 171C of the cylindrical member 171.

The cylindrical wall 165B has a cylindrical shape extending downward from the lower surface of the annular wall 165A. The cylindrical wall 165B is positioned at the center of the annular wall 165A. The lower end of the cylindrical wall 165B is open. The internal space of the cylindrical wall 165B is continued to the internal space of the annular wall 165A. The outer circumferential surface of the cylindrical wall 165B contacts the inner circumferential surface of the communication part 130, over the entire circumference of the outer circumferential surface. The seal body 165 tightly contacts the inner circumferential surface of the communication part 130 so that the seal body 165 is detachable from the atmospheric air communication port 112 by the user.

The extending part 166 has a cylindrical shape extending upward from the upper surface of the annular wall 165A. The extending part 166 extends through the inside in the radial direction of the flange 172, and the extending part 166 reaches the accommodating space 171D of the cylindrical member 171. The upper end of the extending part 166 is positioned above the upper surface of the flange 172. The internal space of the extending part 166 is continued to the internal space of the annular wall 165A. The upward direction is an example of the other side in the first direction.

The contact part 167 has a ring shape extending outward in the radial direction of the extending part 166 from the outer circumferential surface of the extending part 166. The contact part 167 has a flat plate-shape extending in the front-rear direction and the left-right direction. The lower surface of the contact part 167 contacts the upper surface of the flange 172. Accordingly, the seal member 152 is reduced from disengaging downward from the cylindrical member 171. The seal member 152 is an example of the connection part. The seal member 152 is an example of the first seal member.

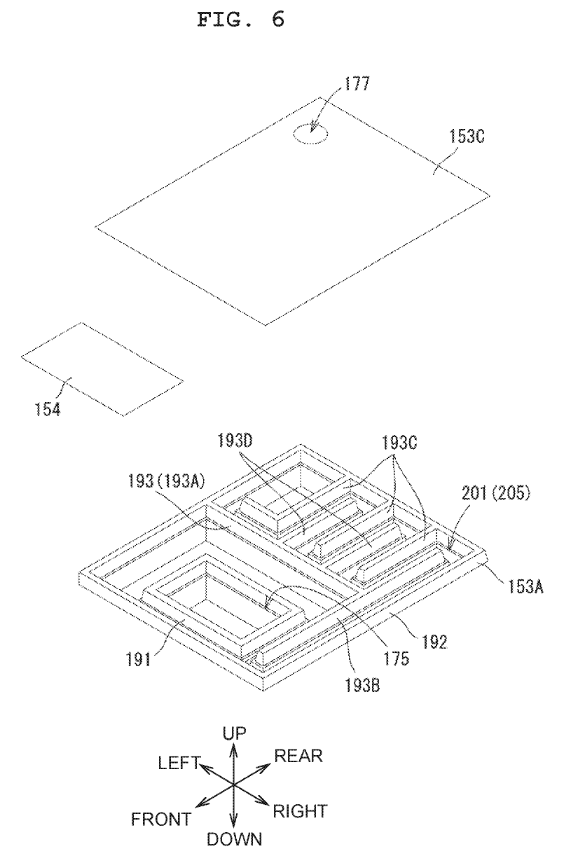

The channel member 153 is positioned in the accommodating space 171D of the cylindrical member 171. The channel member 153 defines a communication channel 205 which allows an internal space of the seal member 152 to communicate with the atmospheric port 182. Specifically, as illustrated in FIGS. 5 and 6, the channel member 153 includes a base plate 153A, a tube member 153B, and a film 153C.

The base plate 153A is fixed to the upper surface of the contact part 167 of the seal member 152. The base plate 153A has a flat plate-shape extending in the front-rear direction and the left-right direction. The base plate 153A has a rectangular shape as viewed in the up-down direction. Note that the base plate 153Ais not specifically limited, provided that the communication channel 205 can be defined among the base plate 153A, the tube member 153B and the film 153C. For example, the base plate 153Amay be circular, elliptic, or polygonal as viewed in the up-down direction.

The base plate 153A includes a base plate through-hole 175 which extends through the base plate 153A in the up-down direction. The base plate through-hole 175 faces the internal space of the seal member 152 in the up-down direction. The base plate through-hole 175 is rectangular as viewed in the up-down direction. The tube member 153B extends downward from the inner surface of the base plate through-hole 175 of the base plate 153A. The tube member 153B is inserted into the internal space of the seal member 152. The lower end of the tube member 153Bis aligned with the lower end 171C of the cylindrical member 171 in the up-down direction. The upper end and the lower end of the tube member 153B are open. Note that the lower end of the tube member 153B may be positioned above the lower end 171C of the cylindrical member 171 in the up-down direction. Further, the lower end of the tube member 153B may be positioned below the lower end 171C of the cylindrical member 171 in the up-down direction.

The base plate 153A includes a surrounding wall 191, a compartment wall 192, and a partition wall 193. The surrounding wall 191 extends upward from an edge of the base plate through-hole 175 on the upper surface of the base plate 153A. The surrounding wall 191 has a rectangular shape as viewed from above. The compartment wall 192 extends upward from the outer edge of the upper surface of the base plate 153A. The compartment wall 192 has a rectangular shape as viewed from above. The upper end of the compartment wall 192 is positioned above the upper end of the surrounding wall 191 in the up-down direction.

The partition wall 193 is positioned inside the compartment wall 192 on the upper surface of the base plate 153A. The partition wall 193 extends upward from the upper surface of the base plate 153A. The upper end of the partition wall 193 is aligned with the upper end of the compartment wall 192 in the up-down direction. The partition wall 193 constructs a groove which has a labyrinthine shape and which is folded back and forth in the front-rear direction between the upper surface of the base plate 153A and the compartment wall 192. Specifically, the partition wall 193 includes a left-right wall 193A, a front-rear wall 193B, three rear labyrinth walls 193C, and two front labyrinth walls 193D. The groove having the labyrinthine shape has a depth and a width of about 1 mm.

The left-right wall 193A extends rightward from the left wall of the compartment wall 192. The left-right wall 193A has a flat plate-shape extending in the up-down direction and the left-right direction. The right end of the left-right wall 193A is spaced apart leftward from the right wall of the compartment wall 192.

The front-rear wall 193B extends from the right end in the front-rear direction. The front-rear wall 193B has a flat plate-shape extending in the front-rear direction and the up-down direction. The front end of the front-rear wall 193B is spaced apart rearward from the front wall of the compartment wall 192. The rear end of the front-rear wall 193B is spaced apart frontward from the rear wall of the compartment wall 192. The front-rear wall 193B is spaced apart leftward from the right wall of the compartment wall 192.

The three rear labyrinth walls 193C extend frontward from the front surface of the rear wall of the compartment wall 192. The three rear labyrinth walls 193C are positioned while being spaced apart from one another in the left-right direction. The three rear labyrinth walls 193C have flat plate-shapes extending in the front-rear direction and the up-down direction. Each of the three rear labyrinth walls 193C is spaced apart leftward from the front-rear wall 193B. The front end of each of the three rear labyrinth walls 193C is spaced apart rearward from the front-rear wall 193B. The leftmost rear labyrinth wall 193C, among the three rear labyrinth walls 193C, has an L-shape bending leftward from a position adjacent closely to the front-rear wall 193B. The left end of the leftmost rear labyrinth wall 193C is spaced apart rightward from the left wall of the compartment wall 192.

The two front labyrinth walls 193D extend rearward from the rear surface of the front-rear wall 193B. The two front labyrinth walls 193D are positioned while being spaced apart from each other in the left-right direction. The two front labyrinth walls 193D have flat plate-shape extending in the front-rear direction and the up-down direction. The rear end of each of the two front labyrinth walls 193D is spaced apart frontward from the front surface of the back wall of the compartment wall 192.

A right front labyrinth wall 193D, of the two front labyrinth walls 193D, is spaced apart leftward from a right rear labyrinth wall 193C of the two front labyrinth walls 193D. The right front labyrinth wall 193D is spaced apart rightward from the central rear labyrinth wall 193C. The left front labyrinth wall 193D is spaced apart leftward from the central rear labyrinth wall 193C. The left front labyrinth wall 193D is spaced apart rightward from the left rear labyrinth wall 193C.

The film 153C is welded to the entirety of the upper ends of the compartment wall 192 and the partition wall 193. The film 153C constructs a channel 201 having a labyrinthine shape among the film 153C, the upper surface of the base plate 153A and the compartment wall 192, and the partition wall 193. The channel 201 having the labyrinthine shape communicates with the base plate through-hole 175 and the tube member 153B.

The film 153C includes a film through-hole 177 which extends through the film 153C in the up-down direction. The film through-hole 177 is positioned to the left of the left rear labyrinth wall 193C. The film through-hole 177 faces the atmospheric port 182 in the up-down direction. The film through-hole 177, the channel 201 having the labyrinthine shape, the base plate through-hole 175, the tube member 153B, and the internal space of the seal member 152 define the communication channel 205. Therefore, the communication channel 205 includes the channel 201 having the labyrinthine shape. The communication channel 205 is a channel through which the external air can flow. In the communication channel 205, the external air successively passes through the atmospheric port 182, the film through-hole 177, the channel 201 having the labyrinthine shape, the gas-liquid separation film 154, the base plate through-hole 175, the tube member 153B, and the internal space of the seal member 152. As a result, the communication channel 205 causes the external air to flow into the ink chamber 111 via the atmospheric air communication port 112. The communication passage 205 is an example of the first communication channel. The material of the film 153C is, for example, PET resin.

The gas-liquid separation film 154 is positioned upstream of the channel 201, which has the labyrinthine shape, in the direction from the internal space of the seal member 152 toward the atmospheric port 182 in the communication channel 205. Specifically, the gas-liquid separation film 154 is welded to the entire circumference of the upper end of the surrounding wall 191. Accordingly, the gas-liquid separation film 154 covers the upper portion of the base plate through-hole 175. The gas-liquid separation film 154 is a porous film including minute pores not allowing the ink to pass through the gas-liquid separation film 154 and allowing the air to pass through the gas-liquid separation film 154. The gas-liquid separation film 154 is composed of, for example, fluororesin such as polytetrafluoroethylene.

### Ink bottle 80

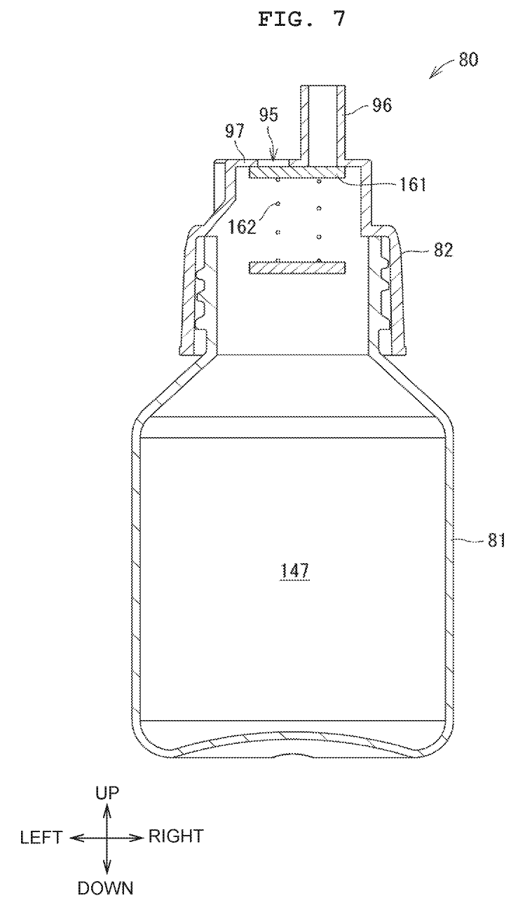

An ink bottle 80 stores the ink to be supplied to the ink tank 90. As illustrated in FIG. 7, the ink bottle 80 includes a bottle body 81, a bottle cap 82, and a valve 161. The bottle body 81 has a cylindrical shape of which upper end is open. The bottle body 81 has an ink storage chamber 147 configured to store the ink. The bottle cap 82 has a cylindrical shape, and the bottle cap 82 is detachably attached to the upper end of the bottle body 81. The internal space of the bottle cap 82 communicates with the ink storage chamber 147.

The bottle cap 82 includes an opening 95 and a bottle tube member 96. The opening 95 and the bottle tube member 96 are positioned in an upper end wall 97 which defines the upper end of the internal space of the bottle cap 82. The opening 95 is a hole which extends through the upper end wall 97 in the up-down direction. The opening 95 allows the internal space of the bottle cap 82 to communicate with the outside. The bottle tube member 96 is positioned to the front of the opening 95. The bottle tube member 96 extends upward from the upper end wall 97. The bottle tube member 96 allows the internal space of the bottle cap 82 to communicate with the outside.

The valve 161 is disposed in the internal space of the bottle cap 82. The valve 161 has a flat plate-shape extending in the front-rear direction and the left-right direction. The valve 161 closes the opening 95 and an opening in the lower end of the bottle tube member 96. The valve 161 is urged upward by a coil spring 162. The valve 161 is movable in the up-down direction between a closed position and an open position. The closed position is a position at which the valve 161 closes the opening 95 and the opening in the lower end of the bottle tube member 96. The open position is a position at which the valve 161 is moved downward from the closed position. The valve 161 located at the open position opens the opening 95 and the opening in the lower end of the bottle tube member 96.

### Connection of Ink Bottle 80 to Ink Tank 90

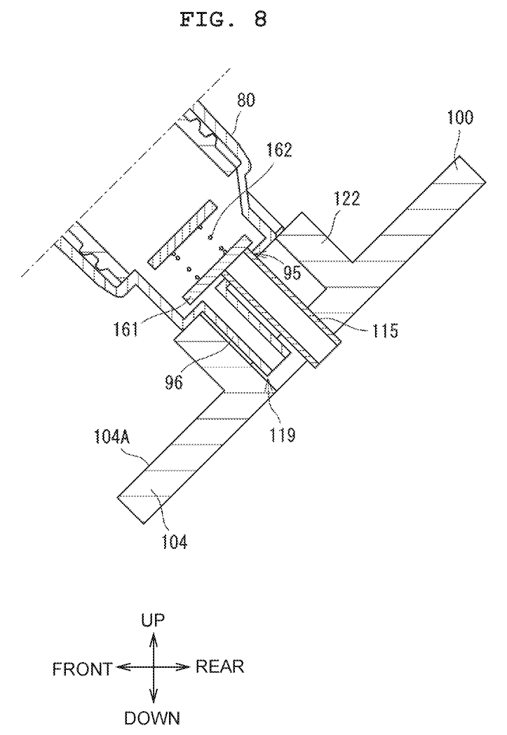

At first, the user removes the tank cap 127 from the annular contact wall 122 of the ink tank 90. Subsequently, as illustrated in FIG. 8, the user inserts the bottle tube member 96 of the ink bottle 80 into the inlet port 119 of the ink tank 90. Simultaneously, the user inserts the tank tube member 115 of the ink tank 90 into the opening 95 of the ink bottle 80. In this situation, the valve 161 is moved from the closed position to the open position against the urging force of the coil spring 162, by the tank tube member 115 inserted into the opening 95. As a result, the ink bottle 80 is connected to the ink tank 90.

As the ink bottle 80 is connected to the ink tank 90, the ink contained in the ink storage chamber 147 flows into the ink chamber 111 of the ink tank 90 via the bottle tube member 96. Simultaneously, the external air flows into the ink chamber 111 via the atmospheric port 182, the communication channel 205, the internal space of the seal member 152, and the atmospheric air communication port 112. Simultaneously, the air contained in the ink chamber 111 flows into the ink storage chamber 147 via the tank tube member 115. In this way, the so-called gas-liquid substitution occurs, and the ink contained in the ink storage chamber 147 is supplied to the ink chamber 111.

### Printing Process

Next, the printing process of the multi-functional peripheral 10 will be described. At first, a sheet 12, which is accommodated in the feed tray 20, is conveyed to the position below the recording part 24, in accordance with the rotation of the feed roller 25 and the conveyance roller part 54. The sheet 12, which is conveyed to the position below the recording head 39, is supported by the platen 42. The recording head 39 ejects the inks downward toward the sheet 12 supported by the platen 42. Accordingly, an image is recorded on the sheet 12.

The liquid surface of the ink is lowered in accordance with the injection of the ink. In this situation, the external air flows into the ink chamber 111 via the atmospheric port 182, the communication channel 205, the internal space of the seal member 152, and the atmospheric air communication port 112. The sheet 12, on which the image has been recorded, is discharged to the discharge tray 21 in accordance with the rotation of the discharge roller part 55.

### Function and Effect of Embodiment

In the above-described embodiment, the ink contained in the ink chamber 111 is consumed as the ink is ejected. In this situation, the external air flows into the ink chamber 111 from the atmospheric port 182 via the communication channel 205, the gas-liquid separation film 154 disposed in the communication passage 205, the internal space of the seal member 152, and the atmospheric air communication port 112. On the other hand, for example, even in a case where the ink contained in the ink chamber 111 flows into the communication channel 205 due to the vibration caused during the transport of the multi-functional peripheral 10, the ink cannot pass through the gas-liquid separation film 154. Accordingly, the ink contained in the ink chamber 111 is reduced from leaking to the outside of the ink tank 90 via the atmospheric port 182.

In the above-described embodiment, for example, the gas-liquid separation film 154 is damaged, in some cases. Further, the gas-liquid separation film 154 malfunctions, in some cases, when the foreign matter or the ink clogs the gas-liquid separation film 154. In the above-described embodiment, the connection component 120, which includes the gas-liquid separation film 154, is detachable with respect to the communication part 130. Accordingly, the gas-liquid separation film 154 can be replaced when the connection component 120 is replaced with a new connection component 120. In other words, the user is not required to replace the tank body 100 with a new tank body 100 in order to replace the gas-liquid separation film 154. Therefore, even the user can easily replace the gas-liquid separation film 154. Further, in a case where the user replaces the connection component 120 with a new connection component 120, the user is not required to replace the tank body 100. Therefore, the user is not required to attach and detach the ink tube 32 with respect to the tank body 100. Accordingly, the outer surface of the ink tank 90 is reduced from being contaminated with the ink due to the attachment/detachment operation of the ink tube 32, and the ejection of the ink from the recording head 39 is reduced from being failed due to the connection failure of the ink tube 32.

In the above-described embodiment, the communication part 130, which defines the atmospheric air communication port 112, is positioned in the upper wall 104. Therefore, the communication part 130 is positioned above the highest position 140A of the liquid surface of the ink storable in the ink chamber 111. Accordingly, the air, which flows into the ink chamber 111 via the atmospheric air communication port 112, hardly enters, as bubbles, into the ink contained in the ink chamber 111. Further, the communication part 130 is positioned above the highest position 140A of the liquid surface of the ink capable of being stored in the ink chamber 111. Therefore, the ink contained in the ink chamber 111 hardly contacts the connection component 120. Accordingly, the outer surface of the ink tank 90 is hardly contaminated with the ink due to the operation of detaching the connection component 120 from the tank body 100. Further, the ink contained in the ink chamber 111 hardly flows into the communication channel 205 of the connection component 120. Accordingly, any deterioration in the function of the gas-liquid separation film 154, which would be otherwise caused by being wetted with the ink, hardly occurs.

In the above-described embodiment, the communication channel 205 includes a channel 201 having the labyrinthine shape which are folded back and forth in the front-rear direction. Accordingly, for example, the ink contained in the ink chamber 111 is hardly evaporated. Further, the ink contained in the ink chamber 111 hardly flows into the atmospheric port 182 due to the vibration caused during the transport of the multi-functional peripheral 10.

In the above-described embodiment, the gas-liquid separation film 154 is welded to the entirety of the circumference of the upper end of the surrounding wall 191 of the base plate 153A. Accordingly, the gas-liquid separation film 154 is positioned upstream of the channel 201 having the labyrinthine shape in the direction from the tube member 153B toward the atmospheric port 182 in the communication channel 205. Accordingly, the ink contained in the ink chamber 111 hardly flows into the channel 201 having the labyrinthine shape in the communication channel 205. Therefore, the ink contained in the ink chamber 111 hardly leaks to the outside via the atmospheric port 182.

In the above-described embodiment, even in a case where the ink tank 90 is disposed in the internal space of the casing 8, the user can remove the gas-liquid separation film 154 simply by removing the connection component 120 from the communication part 130.

In the above-described embodiment, the tank cap 127 detachably closes the inlet port 119. Accordingly, the ink contained in the ink chamber 111 hardly leaks to the outside via the injection port 119.

In the above-described embodiment, the seal member 152 contacts the entire circumference of the inner circumferential surface of the communication part 130. Accordingly, the ink contained in the ink chamber 111 hardly leaks to the outside from between the connection component 120 and the communication part 130.

In the above-described embodiment, the lower surface of the contact part 167 of the seal member 152 contacts the upper surface of the flange 172 of the housing 151. Accordingly, the seal member 152 is hardly disengaged downward from the housing 151.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

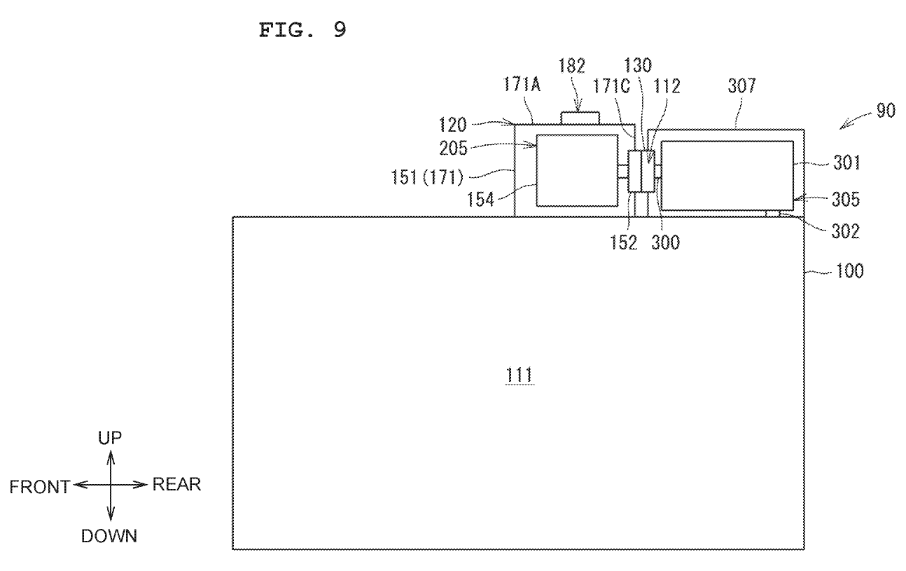

In the above-described embodiment, the atmospheric air communication port 112, which is defined by the communication part 130, is open in the ink chamber 111. However, as illustrated in FIG. 9, the atmospheric air communication port 112 may communicate with the ink chamber 111 via a communication channel 305. The communication passage 305 is a channel through which the air can flow. The communication passage 305 allows the external air to flow into the ink chamber 111 from the atmospheric air communication port 112. Specifically, the communication channel 305 includes a first channel 300, a channel 301 having a labyrinthine shape, and a second channel 302.

The first channel 300 is connected to the atmospheric air communication port 112. The first channel 300 extends in the front-rear direction. The channel 301 having the labyrinthine shape is connected to an upstream end of the first channel 300, in the direction from the ink chamber 111 toward the atmospheric air communication port 112 in the communication channel 305. The channel 301 having the labyrinthine shape is a channel folded back and forth in the front-rear direction or the left-right direction. Note that the configuration of the channel 301 having the labyrinthine shape is similar to the configuration of the channel 201 having the labyrinthine shape in the above-described embodiment. Accordingly, in FIG. 9, any specified shape of the channel 301 having the labyrinthine shape is not illustrated.

The second channel 302 is positioned between the channel 301 and the ink chamber 111 in the direction from the ink chamber 111 toward the atmospheric air communication port 112 in the communication channel 305. The second channel 302 extends in the up-down direction. A downstream end of the second channel 302 is connected to an upstream end of the channel 301. An upstream end of the second channel 302 is open in the ink chamber 111. The communication channel 305 is an example of the second communication channel.

The communication channel 305 is accommodated in the housing 307. The communication part 130 is defined by the housing 307. The atmospheric air communication port 112, which is defined by the inner circumferential surface of the communication part 130, is open frontward.

The seal member 152 of the connection component 120 is open toward the rear, and the seal member 152 is connected to the communication part 130. The atmospheric port 182 may be positioned in the cylindrical part 171Aof the cylindrical member 171. The channel 201 having the labyrinthine shape of the connection component 120 may be omitted.

In the modification illustrated in FIG. 9, for example, the ink contained in the ink chamber 111 is reduced from evaporating by the channel 301 having the labyrinthine shape. Further, the inflow of the ink contained in the ink chamber 111 into the communication part 130, which would be otherwise caused by the vibration during the transport of the multi-functional peripheral 10, is reduced by the channel 301 having the labyrinthine shape.

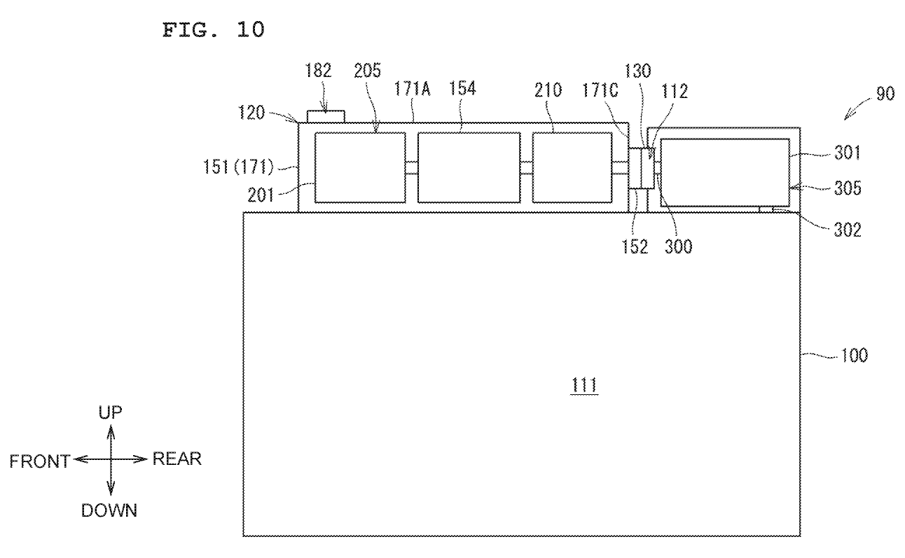

In the above-described embodiment, the gas-liquid separation film 154 is positioned upstream of the channel 201 having the labyrinthine shape in the communication channel 205. However, as illustrated in FIG. 10, a buffer part 210 may be further disposed upstream of the gas-liquid separation film 154 in the communication channel 205. The buffer part 210 is a reserve storage chamber capable of storing the ink. In a case where the ink contained in the ink chamber 111 flows into the connection component 120, the ink spreads in the buffer part 210. Therefore, the flow of the ink is reduced. Accordingly, the ink contained in the ink chamber 111 hardly flows into the gas-liquid separation film 154. Therefore, the deterioration in the function of the gas-liquid separation film 154, which would otherwise be caused due to the wetting of the gas-liquid separation film 154 with the ink, hardly occurs. Note that in FIG. 10, the channel 301 having the labyrinthine shape is illustrated. However, the channel 301 having the labyrinthine shape may be omitted.

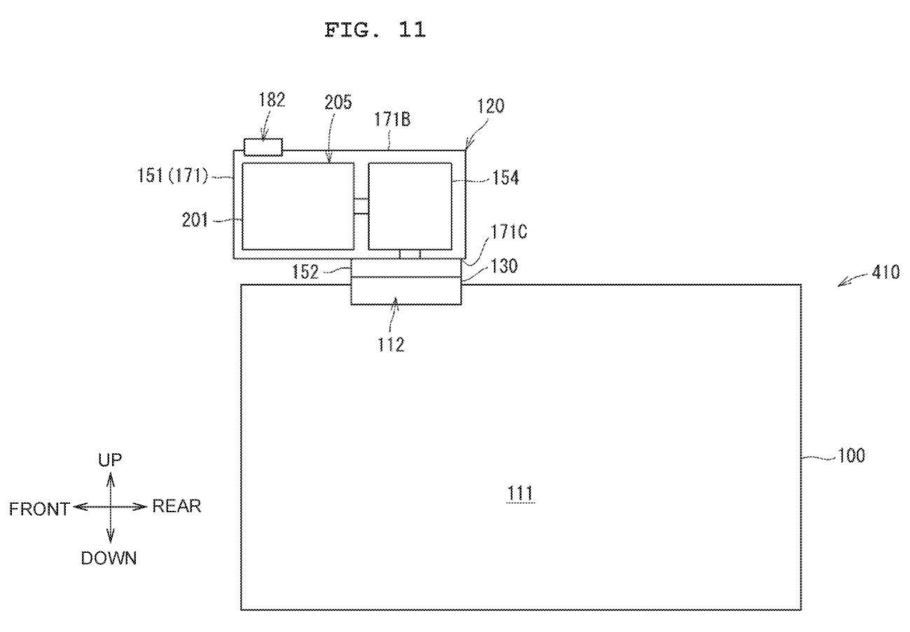

In the above-described embodiment, the connection component 120 is detachably connected to the communication part 130 of the ink tank 90. However, as illustrated in FIG. 11, the connection component 120 may be constructed to be detachable with respect to a cartridge 410 which is detachable with respect to the casing 8 of the multi-functional peripheral 10. In this case, the connection component 120 is detachable with respect to the communication part 130 which defines the atmospheric air communication port 112 of the cartridge 410. The cartridge 410 is an example of the liquid container. Owing to this configuration, for example, during recycling, the connection component 120 can be removed from the communication part 130, and the ink chamber 111 can be cleaned via the atmospheric air communication port 112. Accordingly, the used cartridge 410 is easily recycled.

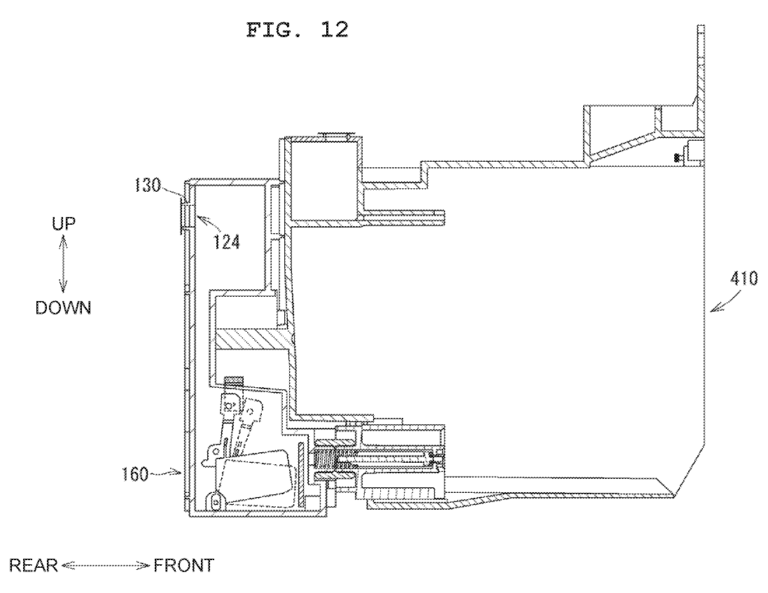

Further, as illustrated in FIG. 12, the connection component 120 may be detachable with respect to the communication part 130 defining the atmospheric air communication port 124 of a sub-tank 160 to which a cartridge 410 is detachably connected. The sub-tank 160 stores the ink supplied from the cartridge 410. The sub-tank 160 is an example of the liquid container and the tank.

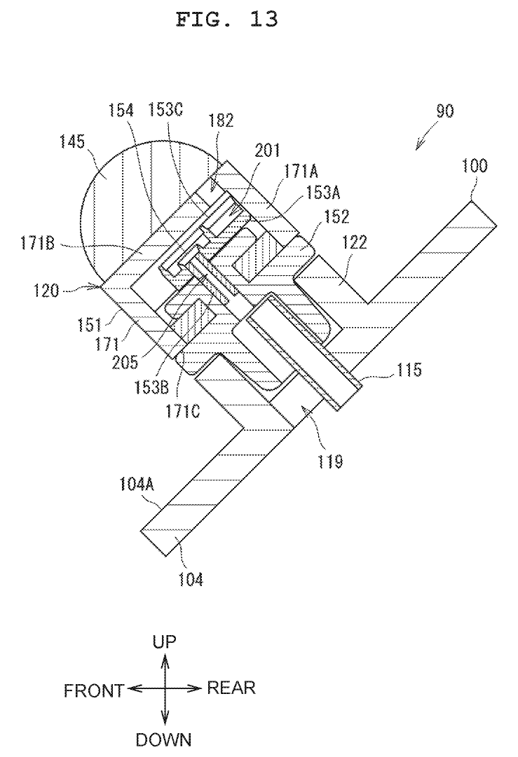

In the above-described embodiment, the connection component 120 is detachable with respect to the communication part 130 of the ink tank 90. However, as illustrated in FIG. 13, the connection component 120 may be constructed such that the connection component 120 is detachable with respect to the annular contact wall 122, rather than the tank cap 127. In this case, the connection component 120 has the function of the tank cap 127. The connection component 120 includes a semicircular operation part 145 which projects upward from the upper surface of the closing wall 171B of the housing 151. The operation part 145 is a part to be gripped by the user when the user removes or reattaches the connection component 120 from or to the annular contact wall 122. The annular contact wall 122 is an example of the communication part. Note that the operation part 145 may project from the outer circumferential surface of the cylindrical member 171A. Further, the operation part 145 may be omitted.

In the modification illustrated in FIG. 13, the liquid surface of the ink contained in the ink chamber 111 is lowered during use of the multi-functional peripheral 10. In this situation, the connection component 120 causes the external air to flow into the ink chamber 111 from the atmospheric port 182 via the communication channel 205, the internal space of the seal member 152, and the inlet port 119. On the other hand, in a case where the user supplies the ink to the ink chamber 111, the user supplies the ink in accordance with the following sequence. At first, the user rotates the cover 70 to the open position. Accordingly, the connection component 120 is exposed so that the connection component 120 is accessible from the front via the opening of the casing 8. Subsequently, the user removes the connection component 120 from the annular contact wall 122, and the user fills the ink chamber 111 with the ink via the inlet port 119.

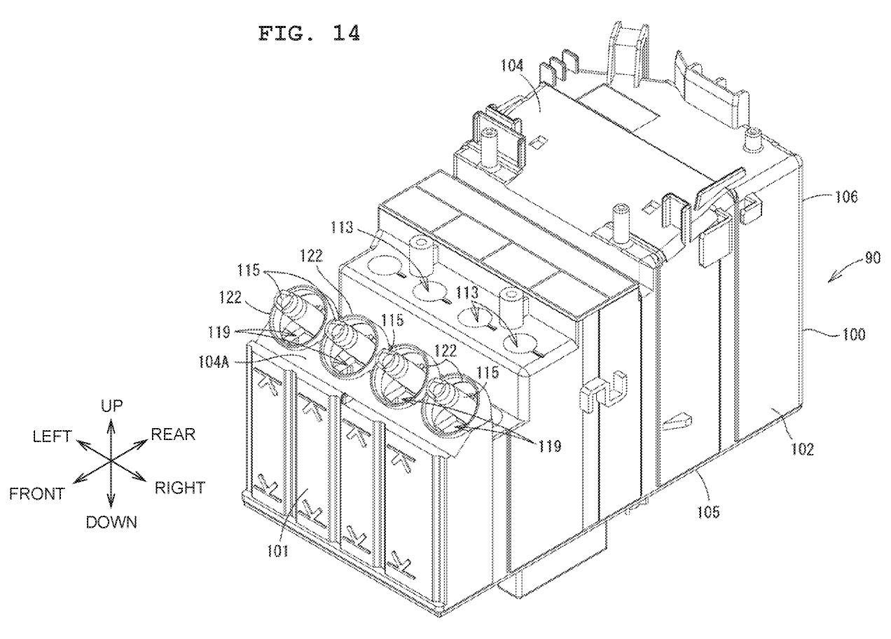

In the modification illustrated in FIG. 13, the connection component 120 causes the external air to flow into the ink chamber 111 from the atmospheric port 182 via the communication channel 205, the gas-liquid separation film 154 disposed in the communication channel 205, the internal space of the seal member 152, and the inlet port 119 during the use of the multi-functional peripheral 10. Accordingly, the atmospheric air communication port 112, which causes the external air to flow into the ink chamber 111, is not required to be disposed in the ink tank 90, in addition to the inlet port 119. Therefore, as illustrated in FIG. 14, the atmospheric air communication port 112 and the communication part 130 which define the atmospheric air communication port 112 can be omitted so as to simplify the structure of the ink tank 90. Note that in FIG. 14, the connection component 120 is omitted.

Further, in the modification illustrated in FIGS. 13 and 14, the connection component 120 is exposed to be accessible from the front via the opening of the casing 8 in a state where the cover 70 is located at the open position. Accordingly, the user can easily replace the connection component 120. Therefore, the gas-liquid separation film 154 is easily replaced.

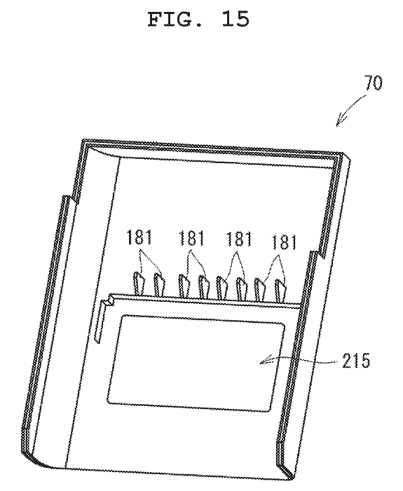

Further, as illustrated in FIG. 15, in the modification illustrated in FIGS. 13 and 14, the cover 70 may include a plurality of retaining parts 181. The plurality of retaining parts 181 retains the connection component 120 so that the connection component 120 does not disengage from the annular contact wall 122 in a state where the cover 70 is closed. In the present embodiment, eight retaining parts 181 are positioned on the inner surface of the cover 70. The eight retaining parts 181 are positioned above an opening 215 of the cover 70. The eight retaining parts 181 are positioned while being spaced apart from one another in the left-right direction. The eight retaining parts 181 project rearward from the inner surface of the cover 70 in the closed state. Each of the eight retaining parts 181 has a right-angled triangular shape in which the hypotenuse is located rearward as viewed in the left-right direction. In other words, each of the eight retaining parts 181 has a right-angled triangular shape in which one of two sides interposing the right angle is positioned on the inner surface of the cover 70.

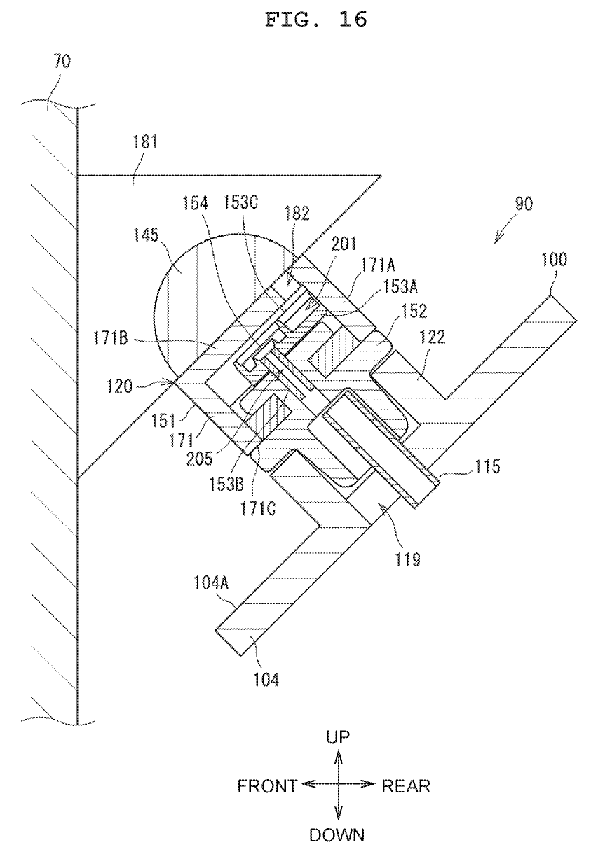

As illustrated in FIG. 16, the eight retaining parts 181 contact the four connection components 120 in a state where the cover 70 is closed. Note that in FIG. 16, only one of the eight retaining parts 181 is illustrated.

Two retaining parts 181, among the eight retaining parts 181, which are adjacent to each other in the left-right direction at the leftmost position, contact the leftmost connection component 120, among the four connection components 120, which is positioned at the leftmost position. The two retaining parts 181, which are adjacent to one another in the left-right direction at the leftmost position, contact, from the left side and the right side, respectively, of the operation part 145 of the leftmost connection component 120 in the upper surface of the closing wall 171B.

Two retaining parts 181, among the eight retaining parts 181, which are the third and fourth from the left contact the second connection component 120 from the left. The third and fourth retaining parts 181 from the left contact, from the left side and the right side, respectively, of the operation part 145 of the second connection component 120 from the left in the upper surface of the closing wall 171B. Two retaining parts 181, among the eight retaining parts 181, which are the fifth and sixth from the left contact the third connection component 120 from the left. The fifth and sixth retaining parts 181 from the left contact, from the left side and the right side, respectively, of the operation part 145 of the third connection component 120 from the left in the upper surface of the closing wall 171B.

Two retaining parts 181, among the eight retaining parts 181, which are adjacent to each other in the left-right direction at the rightmost position, contact the rightmost connection component 120, among the four connection components 120, which is positioned at the rightmost position. The two retaining parts 181, which are adjacent to each other in the left-right direction at the rightmost position, contact, from the left side and the right side, respectively, of the operation part 145 of the rightmost connection component 120 in the upper surface of the closing wall 171B.

In the modification illustrated in FIGS. 13 and 14, the eight retaining parts 181 contact the four connection components 120 in a state where the cover 70 is closed. Therefore, the disengagement of the four connection components 120 from the four annular contact walls 122 is retained in a state where the cover 70 is closed. Note that the eight retaining parts 181 may be disposed closely to the four connection components 120 provided that the eight retaining parts 181 can retain the disengagement of the four connection components 120 from the four annular contact walls 122, respectively. That is, the eight retaining parts 181 may be configured not to contact the four connection components 120 in a state where the cover 70 is closed and the four connection components 120 are mounted to the four annular contact walls 122, respectively.

In the above-described embodiment, the ink tank 90 includes the four connection components 120. However, the four connection components 120 may be constructed as an integrated connection component 120 and may be detachably connected to the four communication parts 130.

In the above-described embodiment, the connection component 120 includes the seal member 152. However, the seal member 152 may be omitted. In this case, the connection component 120 may be connected to the communication part 130, for example, by insertion of the housing 151 into the atmospheric air communication port 112. Further, the connection component 120 may be connected to the communication part 130, for example, by insertion of the communication part 130 into the accommodating space 171D of the housing 151. The housing 151 is an example of the connection part.

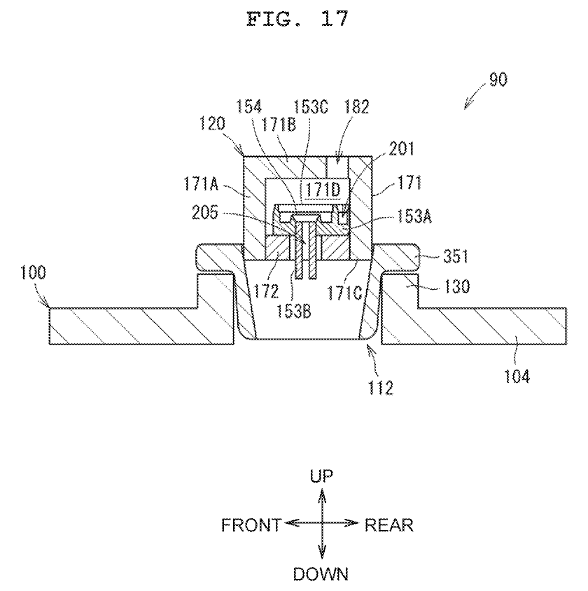

Further, as illustrated in FIG. 17, in a case where the seal member 152 is omitted, the tank body 100 may include an annular seal member 351 attached to the communication part 130. The seal member 351 is an elastic member made of, for example, silicon or rubber. The outer circumferential surface of the seal member 351 is firmly attached to the inner circumferential surface of the communication part 130. The inner circumferential surface of the seal member 351 is a flared surface expanding outward in the radial direction as the inner circumferential surface extends upward. The outer circumferential surface of the seal member 351 is in tight contact with the inner circumferential surface of the communication part 130, over the entire circumference of the outer circumferential surface. The base plate 153A is fixed to the upper surface of the flange 172.

In the modification illustrated in FIG. 17, the connection component 120 is detachably connected to the communication part 130, via the seal member 351, by forcible insertion of the lower end 171C of the cylindrical member 171 into the seal member 351. The lower end 171C of the cylindrical member 171 forcibly inserted into the seal member 351 contacts the inner circumferential surface of the seal member 351, over the entire circumference of the inner circumferential surface. The seal member 351 is an example of the second seal member.

The present specification may be understood as disclosing the following technical concept. The present disclosure relates to a liquid container. The liquid container includes: a storage part including a storage chamber configured to store liquid, and a communication part communicating with the storage chamber; and a connection component detachably connected to the communication part. The connection component includes: a connection part which is connected to the communication part, an atmosphere-open part which is open to outside, a first communication channel via which the atmosphere-open part communicates with the connection part, and a gas-liquid separation film which is disposed in the first communication channel, and which is impermeable to the liquid and permeable to air.

The communication part may be positioned above the highest position of a liquid surface of the liquid storable in the storage chamber.

The air, which flows into the storage chamber via the first communication channel, hardly enters, as bubbles, into the liquid contained in the storage chamber.

The communication part may communicate with the storage chamber via a second communication channel. The second communication channel may include a channel having a labyrinthine shape.

For example, the liquid contained in the storage chamber is reduced from evaporating. Further, the inflow of the liquid contained in the storage chamber into the communication part, which would be otherwise caused by the vibration caused during the transport of the liquid container, is reduced.

The first communication channel may include a channel having a labyrinthine shape.

For example, the evaporation of the liquid contained in the storage chamber is reduced. Further, the inflow of the liquid contained in the storage chamber into the atmosphere-open part, which would be otherwise caused by the vibration caused during the transport of the liquid container, is reduced.

The gas-liquid separation film may be positioned upstream of the channel having the labyrinthine shape in the first communication channel in a direction from the connection part to the atmosphere-open part in the first communication channel.

The liquid contained in the storage chamber hardly flows into the channel having the labyrinthine shape in the first communication channel. Therefore, the liquid contained in the storage chamber hardly leaks to the outside via the atmosphere-open part.

The connection component may further include a buffer part which is positioned upstream of the gas-liquid separation film in a direction from the connection part to the atmosphere-open part.

The liquid contained in the storage chamber hardly flows into the gas-liquid separation film. Therefore, deterioration in the function of the gas-liquid separation film, which would be otherwise caused by the gas-liquid separation film wetted with the liquid, hardly occurs.

The connection component may further include a buffer part which is positioned upstream of the channel having the labyrinthine shape in the first communication channel. The gas-liquid separation film may be positioned upstream of the channel having the labyrinthine shape in the first communication channel, and the gas-liquid separation film may be positioned downstream of the buffer part, in a direction from the connection part toward the atmosphere-open part.

The liquid contained in the storage chamber hardly flows into the gas-liquid separation film. Therefore, deterioration in the function of the gas-liquid separation film, which would be otherwise caused by the gas-liquid separation film wetted with the liquid, hardly occurs. The liquid contained in the storage chamber is reduced from reaching the atmosphere-open part by the buffer part, the gas-liquid separation film, and the channel having the labyrinthine shape. Therefore, the liquid contained in the storage chamber hardly leaks to the outside via the atmosphere-open part.

The liquid container may be a cartridge which is attachable to and detachable from a casing of a liquid ejecting apparatus which is capable of ejecting the liquid.

For example, for recycling of the liquid container, the connection component of the used cartridge can be removed from the communication part, and the inside of the storage chamber can be cleaned through the communication part. Accordingly, the liquid container can be easily recycled.

The liquid container may be a tank which is located in a casing of a liquid ejecting apparatus which is capable of ejecting the liquid.

Even in the tank in which the liquid container is disposed in the casing, the user can remove the gas-liquid separation film by simply removing the connection component from the communication part.

The liquid container may further include a cap. The storage part may include an inlet port via which the storage chamber communicates with outside. The cap may detachably close the inlet port.

The cap prevents the ink contained in the ink chamber from leaking to the outside via the inlet port.

The communication part may be positioned around the inlet port from which the liquid is filled, and the communication part may communicate with the storage chamber via the inlet port.

During use of the liquid container, the connection component functions to cause the air, which flows into the first communication channel from the atmosphere-open part, to flow into the storage chamber. On the other hand, the inlet port functions to fill the liquid during the liquid is being replenished. Accordingly, any atmospheric air communication port, which causes the air to flow into the storage chamber from the outside, is not required to be disposed in the liquid container, in addition to the inlet port. Therefore, the structure of the liquid container is simplified.

The connection part may be a first seal member which contacts an entire circumference of an edge of the communication part.

The first seal member prevents the liquid contained in the storage chamber from leaking to the outside of the liquid container from between the connection component and the communication part.

The connection component may include a cylindrical member, and a flange, the cylindrical member having a cylindrical shape extending in a first direction and including: the atmosphere-open part, and an accommodating chamber accommodating the first communication channel and the gas-liquid separation film, the cylindrical member having an open end disposed on one side in the first direction, and the flange extending in an inward direction from an inner circumferential surface of the cylindrical member. The first seal member may include: a seal body which is positioned at the open end disposed on the one side in the first direction of the cylindrical member; an extending part which extends in the accommodating chamber from the seal body toward the other side opposite to the one side in the first direction, and an contact part which extends in an outward direction, which is opposite to the inward direction, from an outer circumferential surface of the extending part and which contacts the flange from the one side in the first direction.

The contact part contacts the flange from the one side in the first direction. Accordingly, the first seal member is reduced from disengaging from the cylindrical member toward the one side in the first direction.

The connection component may include: a housing which accommodates the first communication channel and the gas-liquid separation film; and an operation part which projects from the housing.

The user can remove the connection component from the communication part by gripping the operation part. On the other hand, the user can mount the connection component to the communication part by gripping the operation part. Accordingly, the user can easily remove and reattach the connection component from and to the communication part.

The storage part may further include: an annular second seal member which is attached to the communication part, the second seal member contacting an entire circumference of an edge of the communication part. The connection component may detachably connect to the communication part via the second seal member.

The second seal member prevents the liquid contained in the storage chamber from leaking to the outside of the liquid container through from between the connection part and the communication part.

The present disclosure relates to a liquid ejecting apparatus. The liquid ejecting apparatus includes: the liquid container as described above; a casing which accommodates the liquid container; and a recording head which is disposed in the casing, and which ejects the liquid. The liquid container is a tank which is disposed in the casing. The casing includes a cover which is configured to move to a closed position and an open position. The connection component is exposed accessibly from outside of the casing in a state where the cover is open.

The user can easily access the connection component through the opening of the casing. Therefore, the user can easily replace the connection component. Accordingly, the gas-liquid separation film is easily replaced.

The cover may include a retaining part which retains disengagement of the connection component so that the connection component is not disengaged from the communication part in a state where the cover is closed.

The connection component is reduced from disengaging from the communication part in a state where the cover is closed.

What is claimed is:

1. A liquid container comprising:
a storage part including:
a storage chamber configured to store liquid; and
a communication part communicating with the storage chamber; and
a connection component configured to be detachably connected to the communication part, the connection component including:
a connection part connected to the communication part;
an atmosphere-open part configured to communicate with outside;
a first communication channel via which the atmosphere-open part communicates with the connection part; and
a gas-liquid separation film which is disposed in the first communication channel, and which is impermeable to the liquid and permeable to air.

2. The liquid container according to claim 1, wherein
the communication part is positioned above a highest position of a liquid surface of the liquid storable in the storage chamber.

3. The liquid container according to claim 1, wherein
the connection component includes a second communication channel,
the communication part communicates with the storage chamber via the second communication channel, and
the second communication channel includes a channel having a labyrinthine shape.

4. The liquid container according to claim 1, wherein
the first communication channel includes a channel having a labyrinthine shape.

5. The liquid container according to claim 4, wherein
the gas-liquid separation film is positioned upstream of the channel having the labyrinthine shape in the first communication channel, in a direction from the connection part to the atmosphere-open part in the first communication channel.

6. The liquid container according to claim 1, wherein
the connection component further includes a buffer part which is positioned upstream of the gas-liquid separation film in a direction from the connection part toward the atmosphere-open part.

7. The liquid container according to claim 4, wherein
the connection component further includes a buffer part which is positioned upstream of the channel having the labyrinthine shape in the first communication channel, and
the gas-liquid separation film is positioned upstream of the channel having the labyrinthine shape in the first communication channel, and the gas-liquid separation film is positioned downstream of the buffer part, in a direction from the connection part toward the atmosphere-open part.

8. The liquid container according to claim 1, wherein
the liquid container is a cartridge being detachable with respect to a casing of a liquid ejecting apparatus configured to eject the liquid.

9. The liquid container according to claim 1, wherein
the liquid container is a tank disposed in a casing of a liquid ejecting apparatus configured to eject the liquid.

10. The liquid container according to claim 9, further comprising a cap, wherein
the storage part includes an inlet port via which the storage chamber communicates with outside, and
the cap detachably closes the inlet port.

11. The liquid container according to claim 1, wherein
the communication part is positioned around the inlet port from which the liquid is filled, and the communication part communicates with the storage chamber via the inlet port.

12. The liquid container according to claim 1, wherein
the connection part is a first seal member which contacts entire circumferential edge of an edge of the communication part.

13. The liquid container according to claim 12, wherein
the connection component includes:
a cylindrical member having a cylindrical shape extending in a first direction, the cylindrical member including the atmosphere-open part, and an accommodating chamber accommodating the first communication channel and the gas-liquid separation film, the cylindrical member having an open end disposed on one side in the first direction; and
a flange extending in an inward direction from an inner circumferential surface of the cylindrical member, and
the first seal member includes:
a seal body positioned at the open end disposed on the one side in the first direction of the cylindrical member;
an extending part extending in the accommodating chamber from the seal body toward the other side opposite to the one side in the first direction; and
a contact part extending in an outward direction, being opposite to the inward direction, from an outer circumferential surface of the extending part and contacting the flange from the one side in the first direction.

14. The liquid container according to claim 12, wherein
the connection component includes:
a housing accommodating the first communication channel and the gas-liquid separation film; and
an operation part projecting from the housing.

15. The liquid container according to claim 1, wherein
the storage part further includes an annular second seal member attached to the communication part, the second seal member contacting an entire circumferential edge of an edge of the communication part, and
the connection component is detachably connected to the communication part via the second seal member.

16. A liquid ejecting apparatus comprising:
the liquid container as defined in claim 11;
a casing accommodating the liquid container; and
a recording head positioned in the casing, wherein
the liquid container is a tank located in the casing,
the casing includes a cover configured to move to a closed position and an open position, and
the connection component is exposed accessibly from outside of the casing in a case where the cover is located at the open position.

17. The liquid ejecting apparatus according to claim 16, wherein
the cover includes a retaining part configured to retain the connection component so that the connection component is not disengaged from the communication part in a case where the cover is located at the closed position.
